(19) United States
(12) Patent Application Publication
(10) Pub. No.: US 2026/0323058 A1
(43) Pub. Date: Oct. 15, 2026

(54) VIDEO DECODING METHOD, VIDEO ENCODING METHOD AND APPARATUS, STORAGE MEDIUM, ELECTRONIC DEVICE, AND PROGRAM PRODUCT

(71) Applicant: Tencent Technology (Shenzhen) Company Limited, Shenzhen (CN)

(72) Inventors: Yingbin WANG, Shenzhen (CN); Xiaozhong Xu, Shenzhen (CN)

(21) Appl. No.: 19/695,912

(22) Filed: Jun. 2, 2026

Related U.S. Application Data
(63) Continuation of application No. PCT/CN2024/105282, filed on Jul. 12, 2024.

(30) Foreign Application Priority Data
Dec. 10, 2023 (CN) 202311692791.4

(51) Int. Cl. H04N 19/44; H04N 19/157; H04N 19/70

(52) U.S. Cl. CPC H04N 19/44; H04N 19/157; H04N 19/70

(57) ABSTRACT

This application discloses a video decoding method, a video encoding method and apparatus, a storage medium, an electronic device, and a program product. The video decoding method includes: obtaining a video bitstream, the video bitstream comprising decoding indication information, the decoding indication information comprising a first intra block copy parameter and a second intra block copy parameter, and the first and second intra block copy parameters being configured for providing a decoding indication on an intra block copy mode including a first sub-mode corresponding to the first intra block copy parameter and a second sub-mode corresponding to the second intra block copy parameter, respectively; and decoding the video bitstream according to the first and second intra block copy parameters.

### CROSS-REFERENCE TO RELATED APPLICATIONS

This application is a continuation application of PCT Patent Application No. PCT/CN2024/105282, entitled “VIDEO DECODING METHOD, VIDEO ENCODING METHOD AND APPARATUS, STORAGE MEDIUM, ELECTRONIC DEVICE, AND PROGRAM PRODUCT” filed on Jul. 12, 2024, which claims priority to and benefit of Chinese Patent Application No. 202311692791.4, entitled “VIDEO DECODING METHOD, VIDEO ENCODING METHOD AND APPARATUS, STORAGE MEDIUM, ELECTRONIC DEVICE, AND PROGRAM PRODUCT” filed on Dec. 10, 2023 with the China National Intellectual Property Administration, all of which are incorporated herein by reference in their entirety.

### FIELD OF THE TECHNOLOGY

This application belongs to the field of video encoding and decoding technologies, and in particular, relates to a video decoding method, a video encoding method, a video decoding apparatus, a video encoding apparatus, a computer-readable storage medium, an electronic device, and a computer program product.

### BACKGROUND OF THE DISCLOSURE

In current video coding standards such as Audio Video Coding Standard 3 (AVS3) and the international video coding standard VVC/H.266 (VVC), an intra block copy (IBC) technology is currently configured for encoding screen content images, and is disabled by default for camera-captured images, resulting in relatively low coding performance of a video bitstream corresponding to the camera-captured images.

### SUMMARY

This application aims to resolve at least one of the technical problems existing in the related art. Therefore, this application provides a video decoding method, a video encoding method, a video decoding apparatus, a video encoding apparatus, a computer-readable storage medium, an electronic device, and a computer program product, to improve coding performance.

According to a first aspect, this application provides a video decoding method, including: obtaining a video bitstream, the video bitstream comprising decoding indication information, the decoding indication information comprising a first intra block copy parameter and a second intra block copy parameter, and the first and second intra block copy parameters being configured for providing a decoding indication on an intra block copy mode including a first sub-mode corresponding to the first intra block copy parameter and a second sub-mode corresponding to the second intra block copy parameter, respectively; and decoding the video bitstream according to the first and second intra block copy parameters.

According to a second aspect, this application provides a video encoding method, including: obtaining video data; and encoding and compressing the video data, to obtain a video bitstream, decoding indication information of the video bitstream including a first intra block copy parameter and a second intra block copy parameter, and the intra block copy parameter being configured for providing a decoding indication on an intra block copy mode.

According to a third aspect, this application provides a video decoding apparatus, including: a first obtaining module and a decoding module. The first obtaining module is configured to obtain a video bitstream, the video bitstream including decoding indication information, the decoding indication information including an intra block copy parameter, and the intra block copy parameter being configured for providing a decoding indication on an intra block copy mode; and the decoding module is configured to decode the video bitstream according to the decoding indication information.

According to a fourth aspect, this application provides a video encoding apparatus, including: a second obtaining module and an encoding module. The second obtaining module is configured to obtain video data; and the encoding module is configured to encode and compress the video data, to obtain a video bitstream, decoding indication information of the video bitstream including an intra block copy parameter, and the intra block copy parameter being configured for providing a decoding indication on an intra block copy mode.

According to a fifth aspect, this application provides a non-transitory computer-readable storage medium, having a computer program stored therein, the computer program, when executed by a processor, implements the video decoding method or the video encoding method.

According to a sixth aspect, this application provides an electronic device, including a memory, a processor, and a computer program stored in the memory and executable on the processor, the processor, when executing the program, implementing the video decoding method or the video encoding method.

According to a seventh aspect, the computer program product includes a computer program, and when being executed by a processor, the computer program implements the video decoding method or the video encoding method.

In the video encoding method, the video decoding method, the video encoding apparatus, the video decoding apparatus, the computer-readable storage medium, the electronic device, and the computer program that are provided in the embodiments of this application, IBC parameters indicating the IBC mode are introduced in a high-level syntax (namely, the decoding indication information) of video encoding and decoding. This allows a corresponding IBC mode to be used for encoding during video encoding according to the image generation manner of the video data, and also allows selection of a suitable IBC tool method set for different image generation scenarios (such as camera photographing or computer generation) during video encoding, which is beneficial to improving encoding performance of the video bitstream of different image generation manners.

### BRIEF DESCRIPTION OF THE DRAWINGS

The foregoing and/or additional aspects and advantages of this application will become apparent and comprehensible in the embodiment description made with reference to the following accompanying drawings.

FIG. 1 is a schematic diagram of a video encoding principle according to an embodiment of this application.

FIG. 2 is a schematic diagram of an intra-frame prediction principle according to an embodiment of this application.

FIG. 3 is a schematic diagram of a slice structure according to an embodiment of this application.

FIG. 4 is a schematic diagram of an intra block copy principle according to an embodiment of this application.

FIG. 5 is a schematic diagram of a block division principle according to an embodiment of this application.

FIG. 6 is a schematic diagram of a framework of a video encoding/decoding system according to an embodiment of this application.

FIG. 7 is a schematic flowchart of a video decoding method according to an embodiment of this application.

FIG. 8 is a schematic flowchart of a video encoding method according to an embodiment of this application.

FIG. 9 is a schematic structural diagram of a video decoding apparatus according to an embodiment of this application.

FIG. 10 is a schematic structural diagram of a video encoding apparatus according to an embodiment of this application.

FIG. 11 is a schematic structural diagram of an electronic device according to an embodiment of this application.

FIG. 12 is a schematic structural diagram of hardware of an electronic device according to an embodiment of this application.

### DESCRIPTION OF EMBODIMENTS

Embodiments of this application are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary and used only for explaining this application, and cannot be construed as a limitation on this application.

A part of technical terms involved in this application are described below.

### 1. Video Encoding:

A video signal may be obtained in two manners: being captured by a camera and being generated by a computer. Due to differences in statistical characteristics, corresponding compression and coding schemes may also vary.

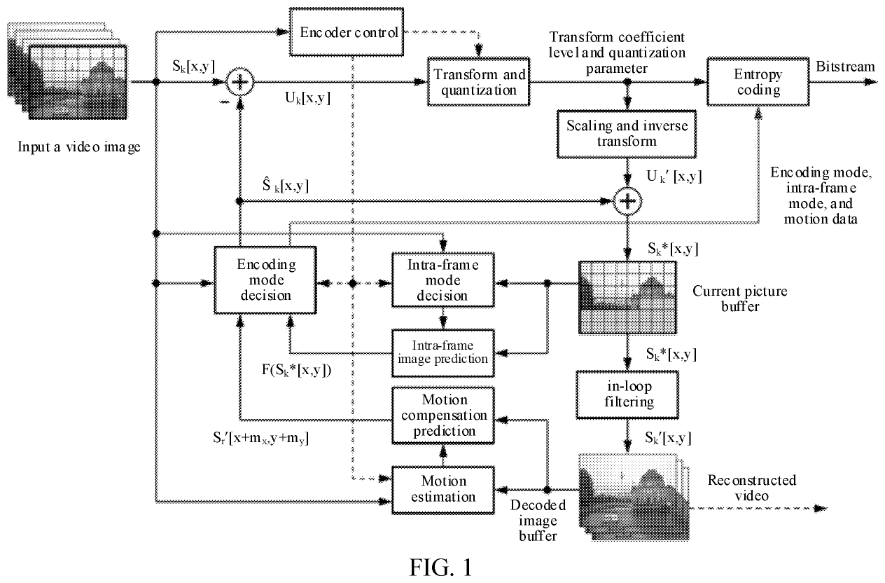

Refer to FIG. 1. In the modern mainstream video coding technologies, the international video coding standard HEVC/H.265 (High Efficiency Video Coding), VVC, and AVS3 are used as examples. A series of operations and processing as follows are performed on an input raw video signal by using a hybrid coding framework.

(1) Block partition structure: An input image (input video pictures) is partitioned into a plurality of non-overlapping processing units according to a size of one image. A similar compression operation is performed on each processing unit. The processing unit is referred to as a CTU or an LCU. The CTU may be more finely partitioned, to obtain one or more basic coding units, each of which is referred to as a CU. Each CU is the most basic element in a coding link. The following describes various coding schemes that may be used for each CU.

(2) Predictive coding: Predictive coding includes intra-frame prediction (intra-picture prediction) and inter-frame prediction (motion-comp prediction). After a raw video signal is predicted by a selected reconstructed video signal, a residual video signal is obtained. An encoder side needs to select, for the current CU, a most suitable one of a plurality of possible predictive coding modes, and inform a decoder side.

Currently, the mainstream video coding standards such as HEVC, VVC, AVS3, Alliance for Open Media Video 1 (AV1), and Alliance for Open Media Video 2 (AV2) all use a block-based hybrid coding framework. Raw video data is partitioned into a series of encoding blocks, and video data is compressed according to a video encoding method such as prediction, transformation, and entropy coding. Motion compensation is a common prediction method used in video coding. The motion compensation derives a prediction value of a current encoding block from a coded region based on a redundancy characteristic of video content in a time domain or a space domain. The prediction method includes: inter-frame prediction, intra block copy prediction, intra string copy prediction, and the like. In a specific coding implementation, these prediction methods may be used alone or in combination. For an encoding block using these prediction methods, one or more two-dimensional displacement vectors usually need to be explicitly or implicitly encoded in a bitstream, which indicates a displacement of a current block (or a co-located block of the current block) relative to one or more reference blocks thereof.

The displacement vector may have different names in different prediction modes and different implementations. In this specification, the displacement vector is described in the following manner: (1) A displacement vector in inter-frame prediction is referred to as a motion vector (MV); (2) a displacement vector in intra block copy is referred to as a block vector (BV); and (3) a displacement vector in intra string copy is referred to as a string vector (SV). Related technologies in inter-frame prediction and intra block copy prediction are described below.
a. Intra-frame prediction: A predicted signal comes from a region that has been encoded and reconstructed in the same image.
b. Inter-frame prediction: A predicted signal comes from another image (referred to as a reference image) that has been encoded and that is different from a current image.

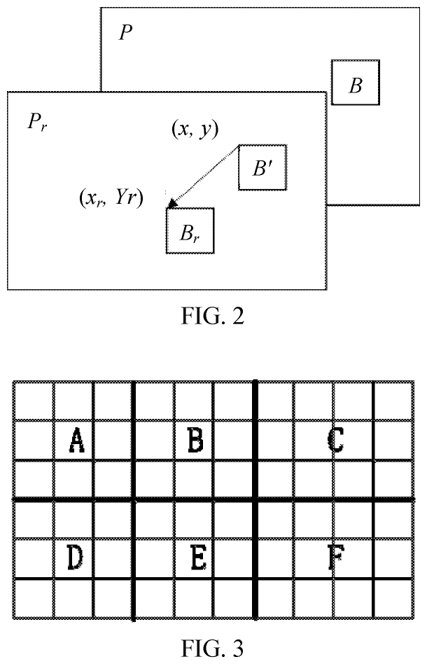

As shown in FIG. 2, inter-frame prediction uses correlation in a video time domain to predict a pixel of a current image by using a pixel of an adjacent encoded image, so as to effectively remove video time domain redundancy and effectively save a bit of encoded residual data. P is a current frame, Pr is a reference frame, B is a current to-be-encoded block, and Br is a reference block of B. A coordinate position of B′ in an image is the same as that of B. Coordinates of Br are (xr, yr), and coordinates of B′ are (x, y). A displacement between a current encoding block and a reference block thereof is referred to as a motion vector (MV), that is, MV=(xr−x, yr−y).

In consideration of strong correlation of temporally or spatially adjacent blocks, an MV prediction technology may be used for further reducing bits required for encoding an MV. In the H.265/HEVC, inter-frame prediction includes two MV prediction technologies: Merge and AMVP.

(3) Transform coding and quantization: After discrete Fourier transform (DFT), discrete cosine transform (DCT), and other transform operations, the residual video signal is converted into a transform domain, which is referred to as a transform coefficient. A lossy quantization operation is further performed on a signal in the transform domain, and a specific amount of information is lost, so that the quantized signal is beneficial to compression expression. In some video coding standards, there may be more than one transform manner to be selected. Therefore, an encoder side also needs to select one of the transforms for the current coding CU and inform a decoder side. Fineness of quantization is usually determined by a quantizer parameter (QP). A larger QP value indicates that coefficients with a larger value range are quantized into the same output, which usually results in greater distortion and a lower bit rate. Conversely, a smaller QP value indicates that coefficients with a smaller value range are quantized into the same output, which usually results in less distortion and corresponds to a higher bit rate.

(4) Entropy coding or statistical coding: Statistical compression coding is performed on a quantized transform domain signal according to a frequency of each value, and finally a binarized (0 or 1) compressed bitstream is output. In addition, other information is generated during coding, such as a selected mode and a motion vector, and entropy coding also needs to be performed to reduce the bit rate. Statistical coding is a lossless coding manner that can effectively reduce the bit rate required to express the same signal. A common statistical coding scheme is variable length coding (VLC) or content adaptive binary arithmetic coding (CABAC).

(5) Loop filtering: A reconstructed decoded image may be obtained by performing operations such as inverse quantization, inverse transform, and predictive compensation (inverse operations in (2) to (4) above) on an encoded image. Compared with an original image, the reconstructed image is different from the original image in some information due to influence of quantization, that is, distortion is generated. A filtering operation is performed on the reconstructed image by using a filter such as a deblocking filter, an SAO filter, or an ALF, to effectively reduce a degree of distortion caused by quantization. Because the filtered reconstructed image is used as a reference for a subsequent encoded image to predict a future signal, the filtering operation is also referred to as loop filtering and a filtering operation in an encoding loop.

2. Video decoding: Video decoding is an inverse process of video encoding. It can be learnt from the foregoing encoding process that on a decoder side, for each CU, after obtaining a video bitstream, a decoder first performs entropy decoding, to obtain various mode information and quantized transform coefficients. Each coefficient is inversely quantized and inversely transformed, to obtain the residual signal. In addition, a predicted signal corresponding to the CU may be obtained according to known encoding mode information, and a reconstructed signal may be obtained by adding the residual video signal and the predicted signal. Finally, a loop filtering operation needs to be performed on a reconstructed value of a decoded image, to generate a final output signal.

3. Video Bitstream Structure

### (1) Video Sequence

A video sequence is a highest-level syntactic structure of a bitstream (namely, a video bitstream). The video sequence starts with a 1^{st} sequence header, and a sequence end code or a video editing code indicates ending of a video sequence. A sequence header between the 1^{st} sequence header of the video sequence and the sequence end code or the video editing code that first appears is a repeating sequence header. Each sequence header is followed by one or more encoded images, and each image is preceded by an image header. The encoded images are sorted in a bitstream order in a bitstream, and the bitstream order is the same as a decoding order. The decoding order may be different from a display order.

### (2) Image

An image may be a frame or a field, and encoding data thereof starts with an image start code and ends with a sequence start code, a sequence end code, or a next image start code.

An image type includes: an I frame image (namely, an image of a first type); a P frame image (namely, an image of a second type); and a B frame image (namely, an image of a third type). A fully encoded frame is referred to as an I frame, a frame that is generated with reference to a previous I frame and that includes encoding of only a different part is referred to as a P frame, and a frame encoded with reference to a previous frame and a subsequent frame is referred to as a B frame.

### (3) Slice

A slice is a rectangular region (such as a region A and a region B) in an image, which includes parts of several maximum coding units in an image. Slices do not overlap with each other. A slice structure is as shown in FIG. 3.

### (4) Maximum Coding Unit, Coding Tree, and Coding Unit

An image is partitioned into maximum coding units (such as a CTU in video encoding). The maximum coding units do not overlap with each other. A sample at an upper left corner of the maximum coding unit does not exceed an image boundary, and a sample at a lower right corner of the maximum coding unit can exceed the image boundary.

The coding tree determines a partition manner of partitioning the maximum coding unit into a plurality of coding units (such as the CU in video encoding), such as a binary tree, a quadtree, and an enhanced quadtree. One coding unit can be used as one image block.

The coding unit is partitioned into one or more transform blocks, and the transform block is a basic unit for transform coding.

### 4. Intra Block Copy (IBC)

IBC is an intra coding tool used in screen content coding (SCC) extension of HEVC, which significantly improves coding efficiency of screen content. The IBC technology is also used in AVS3, VVC, and AV1 to improve coding performance of screen content. The IBC can effectively save bits required for coding pixels by using spatial correlation of screen content videos and using pixels of a currently coded image to predict pixels of a current to-be-coded block. FIG. 4 is a schematic diagram of an IBC technology. A displacement between a current encoding block and a reference block thereof is referred to as a block vector (BV).

### 5. AVS3 Block Partitioning Structure

In the AVS3, a basic block partitioning structure of quadtree (QT)+binary tree (BT)+enhanced quadtree (EQT) is used. Quadtree partitioning is used in the previous generation AVS2 standard, to partition one CU into four sub-CUs. In addition to supporting quadtree partitioning, the AVS3 further supports binary tree (BT) partitioning and EQT partitioning. The BT can partition one CU into two sub-CUs, that is, one on the left and one on the right, or one on the top and one on the bottom. The EQT includes two I-shaped partitioning manners, that is, a horizontal partitioning manner and a vertical partitioning manner, to partition one CU into four sub-CUs.

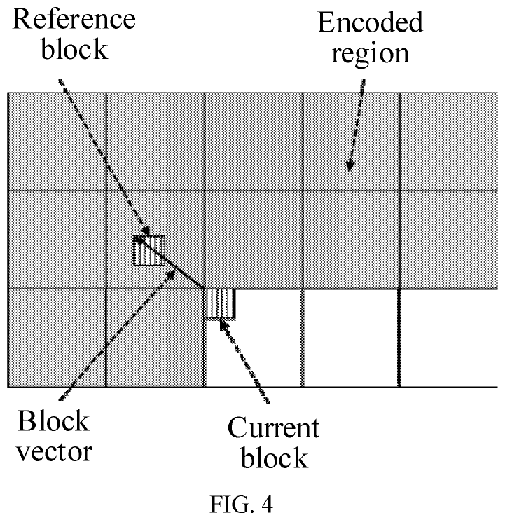

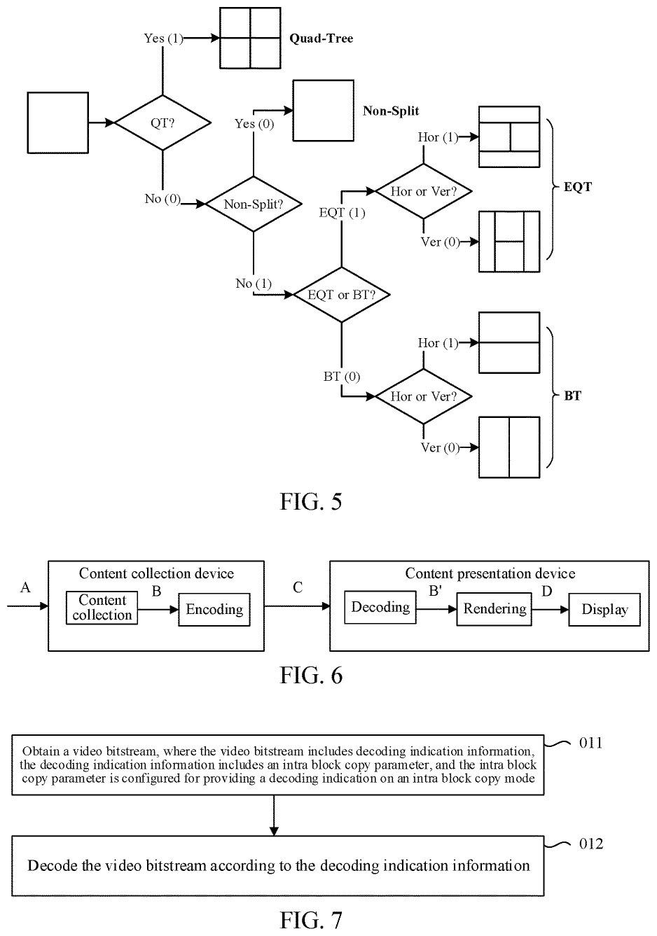

Refer to FIG. 5. A representation manner of the basic block partitioning structure of QT+BT+EQT in the bitstream in the AVS3 is as shown in FIG. 5. First, determine whether a partitioning manner is the QT. If the partitioning manner is the QT, directly perform quadtree partitioning. If the partitioning manner is not the QT, further determine whether or not to perform partitioning. If partitioning is skipped, end determining. If partitioning is required, determine whether the partitioning manner is the EQT or the BT. Regardless of whether the partitioning manner is the EQT or the BT, determine whether to perform horizontal partitioning or vertical partitioning.

The video decoding method and the video encoding method that are provided in the embodiments of this application can be applied to a video encoding and decoding system. The video encoding and decoding system may include a content creation device (corresponding to an encoding device) and a content presentation device (corresponding to a decoding device). The content creation device may refer to an electronic device used by a provider of video data (for example, a content creator of the video data). The electronic device may be a terminal (for example, a personal computer (PC), a smart mobile device (for example, a smartphone)), or a server.

The server may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a CDN, and a big data and artificial intelligence platform. The content presentation device may be an electronic device used by a user of the video data (for example, a viewer of the video data, namely, a service object). The electronic device may be a terminal (for example, a personal computer (PC), a smart mobile device (for example, a smartphone), a VR device (for example, a VR helmet or VR glasses), a smart home appliance, a vehicle-mounted terminal, or an aircraft). A client is integrated in the electronic device.

The client may be a client having a function of displaying data information such as text, an image, audio, and a video, including but not limited to a multimedia client (for example, a video client), a social client (for example, an instant messaging client), an information application (for example, a news client), an entertainment client (for example, a game client), a shopping client, a vehicle-mounted client, a browser, and the like. The client may be a standalone client or may be an embedded subclient integrated into a client (for example, a social client). This is not limited herein.

The content creation device and the content presentation device may be the same device, or may be different devices. Both the content creation device and the content presentation device include a plurality of modules, and different modules are configured to implement different functions. These modules may be integrated into the same electronic device, or may be located in different electronic devices. The content creation device may be configured to implement functions such as collecting and encoding the video data, and correspondingly, the content presentation device may be configured to decode, render, and display an encapsulated file. FIG. 6 is a schematic diagram of a framework of a video encoding/decoding system of video data according to an embodiment of this application.

In FIG. 6, on the content creation device side, a real-world visual scene is captured and collected by a set of cameras or a camera device with a plurality of lenses and sensors. A collected camera captured image A is video data B, and the video data B includes a plurality of frames of captured images. Alternatively, on the content creation device side, a plurality of frames of screen content images A may be used as video data B. After content is collected, the video data B is encoded, to obtain a video bitstream C, and the video bitstream C is sent to the content presentation device.

On the content presentation device side, the video bitstream Cis decoded, then decoded video data B′ is rendered, to obtain a rendered video D, and display is performed according to the video D.

The encoding and decoding technology involved in this application may be implemented based on a cloud technology. For example, a cloud server is used as the content creation device. The cloud technology is a hosting technology that unifies a series of resources such as hardware, software, and networks in a wide area network or a local area network, to implement computing, storage, processing, and sharing of data.

Based on the foregoing introduction of basic concepts and related scenarios, the embodiments of this application provide a video encoding method, a video decoding method, a video encoding apparatus, a video decoding apparatus, a computer storage medium, and an electronic device.

To support the video encoding method in the embodiments of this application, in the embodiments of this application, several descriptive fields are added at a system layer and a corresponding high-level syntax data structure is defined based on the related art. In the following content, detailed introduction is provided for the foregoing video encoding method with reference to various syntax tables.

FIG. 7 is a schematic flowchart of a video encoding method according to an embodiment of this application. The following steps are specifically included.

Step 011: Obtain a video bitstream, where the video bitstream includes decoding indication information, the decoding indication information includes an intra block copy parameter, and the intra block copy parameter is configured for providing a decoding indication on an intra block copy mode.

Step 012: Decode the video bitstream according to the decoding indication information.

Specifically, a bitstream, namely, a video bitstream, can be obtained by encoding and compressing video data (such as at least one of an image captured by a camera and a screen content image generated by a computer).

An image generation manner of the video bitstream may be determined according to a generation manner of the video data that is used to generate the video bitstream. For example, the image generation manner of the video bitstream may include a camera photographing manner and a computer (which specifically may be an electronic device) generation manner. When the video bitstream is generated from the image captured by the camera, it can be determined that the image generation manner of the video bitstream is the camera photographing manner. When the video bitstream is generated from the screen content image generated by the computer, it can be determined that the image generation manner of the video bitstream is the computer generation manner.

A decoder side can obtain the video bitstream sent by an encoder side. The video bitstream includes the decoding indication information for decoding indication. The decoder side can decode the video bitstream according to the decoding indication information.

The decoding indication information is configured for providing a decoding indication on different data in the video bitstream. The decoding indication information includes a video sequence, and the video sequence is a highest-level syntax structure of the video bitstream.

The decoding indication information includes an intra block copy parameter, namely, an IBC parameter. The intra block copy parameter is configured for providing a decoding indication on an intra block copy mode. In other words, the IBC parameter is configured for indicating an IBC mode used when the video bitstream is encoded.

The intra block copy mode matches an image generation manner corresponding to the video bitstream. For example, video sequences of different image generation manners correspond to different IBC modes.

The IBC parameter is configured for representing an IBC technology used when the video data is encoded. For example, the IBC parameter is configured for representing whether the IBC mode is allowed and an IBC mode used during encoding.

In some embodiments, the IBC parameter is set in at least one of sequence-level parameter information, image-level parameter information, slice-level parameter information, and block-level parameter information of the video sequence.

In some embodiments, the IBC mode includes a first sub-mode and a second sub-mode. For example, the first sub-mode and the second sub-mode respectively correspond to the camera photographing manner and the computer generation manner; or the first sub-mode and the second sub-mode respectively correspond to the computer generation manner and the camera photographing manner.

An intra block copy parameter corresponding to the first sub-mode is set in at least one of the sequence-level parameter information, the image-level parameter information, the slice-level parameter information, and the block-level parameter information of the video sequence; and an intra block copy parameter corresponding to the second sub-mode is set in at least one of the sequence-level parameter information, the image-level parameter information, the slice-level parameter information, and the block-level parameter information of the video sequence.

In some embodiments, the intra block copy parameter corresponding to the first sub-mode is set in the image-level parameter information, and the intra block copy parameter corresponding to the second sub-mode is set in the image-level parameter information.

Alternatively, the intra block copy parameter corresponding to the first sub-mode is set in the sequence-level parameter information, and the intra block copy parameter corresponding to the second sub-mode is set in the image-level parameter information.

Alternatively, the intra block copy parameter corresponding to the first sub-mode is set in the image-level parameter information, and the intra block copy parameter corresponding to the second sub-mode is set in the sequence-level parameter information.

The IBC parameter set in the sequence-level parameter information is effective for the entire video sequence; the IBC parameter set in the image-level parameter information is effective for a corresponding image; the IBC parameter set in the slice-level parameter information is effective for a corresponding image slice; and the IBC parameter set in the block-level parameter information is effective for a corresponding image block.

In some embodiments, the sequence-level parameter information includes a sequence header, and the sequence header includes the intra block copy parameter.

The video sequence includes the sequence header, and the sequence header is followed by one or more encoded images. The IBC parameter set in the sequence header is effective for all the encoded images following the sequence header. In other words, the encoded images following the sequence header can be encoded according to the IBC parameter of the sequence header.

In some embodiments, the image-level parameter information includes an image header, and the image header includes the intra block copy parameter.

The video sequence includes an image header. There is an image header before the encoded images following the sequence header. The IBC parameter set in the image header is effective for all the encoded images following the image header. In other words, the encoded images following the image header can be encoded according to the IBC parameter of the image header.

In some embodiments, the slice-level parameter information includes a slice header, and the slice header includes the intra block copy parameter.

The video sequence includes the slice header. The encoded image is partitioned into a plurality of slices, and there is a slice header before the slices. The IBC parameter set in the slice header is effective for all the slices following the slice header. In other words, the slices following the slice header can be encoded according to the IBC parameter of the slice header.

In some embodiments, the block-level parameter information includes an encoding block (or an encoding unit), a prediction block (or a prediction unit), and a transform block (or a transform unit). The block-level parameter information may include the intra block copy parameter.

During encoding, the encoding block, the prediction block, and the transform block can be separately encoded according to the IBC parameter in the encoding block, the prediction block, and the transform block.

An IBC-related technology in this application includes a plurality of preset tool methods, forming an IBC tool list.

In some embodiments, the tool method includes at least one of an adaptive motion vector resolution (AMVR) method, an adaptive block vector resolution (ABVR) method, a class-based block vector prediction (CBVP) method, a filtered intra block copy (FIBC) prediction method, an intra block copy mode method with fractional pixel precision (Fractional pel IBC, IBC-FRAC), a symmetric intra block copy (SIBC) prediction mode method, a reconstruction-reordered intra block copy (RRIBC) prediction mode method, an inter prediction correction (InterPC) method, an intra block copy prediction method with local illumination compensation, an intra block copy merge method with block vector differences (IBC-MBVD), a combined intra block copy and intra prediction (IBC-CIIP) mode method, an intra block copy mode with geometric partitioning (IBC-GPM), an intra block copy mode method with template matching (IBC-TM), an intra block copy motion vector prediction merge method (IBC BVP-merge), and a bi-predictive intra block copy (IBC Bi-Pred) mode method.

The tool methods are described below.

### (1) Adaptive Block Vector Resolution

A CU-level adaptive motion vector resolution (AMVR) scheme is introduced in the international video coding standard VVC/H.266 (versatile video coding, VVC). The AMVR allows encoding on a motion vector difference (MVD) of a CU at different levels of precision. According to a mode of the current CU, the MVD of the current CU can adaptively select a quarter-luma sample, a half-luma sample, an integer-luma sample, or a four-luma sample. In the AVS3 standard, the ABVR technology is used, and the ABVR allows selection of integer-luma sample precision or four-luma sample precision for a block vector difference (BVD) of IBC.

### (2) Class-Based Block Vector Prediction

In the AVS3, the class-based block vector prediction (CBVP) is used, which is similar to history information-based motion vector prediction (HMVP). In the method, a history information-based block vector prediction (HBVP) list is first used to store information about a historical IBC encoding block. In addition to recording BV information of the historical encoding block, the history information-based block vector prediction list further records information such as a position and a size of the historical encoding block. For the current encoding block, candidate BVs in the HBVP are classified according to the following conditions:
Class 0: An area of the historical encoding block is greater than or equal to 64 pixels;
class 1: A frequency of a BV is greater than or equal to 2;
class 2: Coordinates of the historical encoding block at an upper left corner are located at the left of coordinates at an upper left corner of the current block;
class 3: Coordinates of the historical encoding block at an upper left corner are located above coordinates at an upper left corner of the current block;
class 4: Coordinates of the historical encoding block at an upper left corner are located at the upper left of coordinates at an upper left corner of the current block;
class 5: Coordinates of the historical encoding block at an upper left corner are located at the upper right of coordinates at an upper left corner of the current block; and
class 6: Coordinates of the historical encoding block at an upper left corner are located at the lower left of coordinates at an upper left corner of the current block.

Instances in each category are arranged in reverse order of an encoding order (the closer the encoding order is to the current block, the higher the instance ranks). A BV corresponding to a 1^{st} historical encoding block is a candidate BV corresponding to the class. Then, a candidate BV corresponding to each category is added to a CBVP list in an order of the class 0 to the class 6. The list is used to export a predicted block vector.

A reference software platform (Enhanced Compression Model, ECM) with a next-generation international video coding standard includes a clustering-based block vector prediction (BVP) mode. The following modification is performed by comparing construction of an IBC merge/AMVP candidate list with a VVC inter-frame merge/AMVP:

During construction of the IBC AMVP candidate list, when two BV candidate components are non-zero, clustering of BVP candidates can be applied. If there are more than two valid BV candidates and a maximum of six candidates can be clustered, an L2 distance is used for clustering.

A clustering method is applied in an order of a candidate list. Candidates allocated to a group are removed from the list, so that subsequent clustering is performed. In each group, a BVP with a lowest template matching cost is selected as a representative candidate of the group. Finally, representative candidates of the first two groups are selected as candidates of the IBC AMVP list.

Merge and the advanced motion vector prediction (AMVP) are two motion vector prediction methods, and these motion vector prediction methods are used in video coding standards such as H.265/HEVC, H.266/VVC, and AVS3.

### (3) Filtered Intra Block Copy Prediction

An additional filtering IBC mode is introduced in the ECM, where a filter is used in an IBC predictor, and the filter is obtained by minimizing a mean square error (MSE) between a current template and a reference template.

Output of the filter is calculated as follows:

predLuma Val=c0C+c1N+c2S+c3E+c4 W+c5P+c6B, where
a nonlinear term P represents a second power of a center sample C and is scaled to a range of sample values of content; and

P=(C*C+midVal)>>bitDepth, where
an offset term B represents a scalar offset between input and output and is set to an intermediate brightness value (512 for 10-bit content).
   (4) IBC Mode with Fractional Pixel Precision

In additional options, selection of a block vector resolution is expanded, which further includes a quarter-pixel resolution in addition to a full-pixel resolution and a 4-pixel resolution. Similar to an inter-frame adaptive motion vector resolution (AMVR) syntax, a 1st bit is passed to indicate whether the BV is at the quarter-pixel resolution, and a 2^{nd} bit is passed to switch between the full-pixel resolution and the 4-pixel resolution. An interpolation filter is used in a brightness (8-point interpolation) component and a chrominance (6-point interpolation) component of the IBC block. For a template-based IBC tool, a 2-point bilinear interpolation filter is used to generate a template prediction block. Reference sample filling is performed when some reference samples are located outside an IBC reference region. When necessary, filling in a horizontal direction is first performed, and then filling in a vertical direction is performed.

### (5) Reconstruction-Reordered Intra Block Copy Prediction Mode

The ECM allows use of a reconstruction-reordered mode for an IBC encoding block (RR-IBC). When the RR-IBC is applied, a sample in a reconstructed block is flipped according to a flip type of a current block. At an encoder side, a raw block is flipped before motion search and residual calculation are performed, and the predicted block is not flipped. At a decoder side, the reconstructed block is flipped back to restore the raw block. For an RR-IBC encoded block, two flipping methods, namely, horizontal flipping and vertical flipping are supported. The SIBC is another flipping-based intra block copy prediction mode. Different from the RR-IBC, a predicted value is flipped based on the SIBC.

(6) Intra Block Copy Prediction with Local Illumination Compensation

Intra block copy with local illumination compensation (IBC-LIC) is configured for compensating for local illumination variations between an IBC-coded CU and a predicted block thereof in an image by deriving a linear equation. A parameter of a linear equation is the same as that of the local illumination compensation (LIC) for inter-frame prediction, and is derived through a template between the current block and the reference block. The reference template is generated by using a block vector in the IBC-LIC. The IBC-LIC may be applied to an IBC AMVP mode and an IBC merge mode.

(7) IBC Merge Mode with Block Vector Differences

In the IBC-MBVD, a distance set of 1 pixel to 128 pixels is included, and there are two horizontal directions and two vertical directions. In the method, the candidate BVP is selected based on the IBC merge and the BVD is determined from the distance set and a direction set, to derive the BV from the BVP and the BVD.

### (8) Combined IBC and Intra Prediction Mode

Combined intra block copy and intra-frame prediction (IBC-CIIP) is a coding tool that is configured for obtaining CUs of two predicted signals by using the IBC and intra-frame prediction, and then performing a weighted sum on the two predicted signals to generate a final predicted signal.

(9) IBC Mode with Geometric Partitioning

Through the intra block copy with a geometric partitioning mode (IBC-GPM), a CU is partitioned into two sub-partitions through geometric partitioning. Predicted signals of the two sub-partitions are generated by using the IBC and intra-frame prediction. When the IBC-GPM is used, a geometric partitioning mode set flag is passed, to indicate whether to select a 1^{st} or 2^{nd} geometric partitioning mode set, and then a geometric partitioning mode index is passed. An IBC-GPM intra-frame flag is passed, to indicate whether to perform intra-frame prediction on a 1^{st} sub-partition. When intra-frame prediction is performed on a sub-partition, an intra-frame prediction mode index is passed. When the IBC is performed on a sub-partition, a merge index is passed.

(10) IBC Mode with Template Matching

In the IBC, template matching is used in an IBC merge mode and an IBC AMVP mode.

In the IBC-TM merge mode, selected candidates are optimized in a template matching method. In the IBC-TM AMVP mode, a maximum of three candidates are selected from an IBC-TM merge list. The three selected candidates are refined in a template matching method and are sorted according to a template matching cost obtained by the three selected candidates. Then, only the first two candidates are considered in a motion estimation process as usual. In the IBC-TM merge mode, all refinement is performed with integer-pixel precision, and in the IBC-TM AMVP mode, refinement can be performed with the integer-pixel precision or 4-pixel precision according to an AMVR value. In the refinement, only a sample that does not require an interpolation is accessed. In two cases, a refined motion vector and a template used in each refinement step need to conform to a constraint of a reference region.

### (11) Intra Block Copy Motion Vector Prediction Merge Mode Method and Bi-Predictive Intra Block Copy Mode Method

IBC BVP-merge is similar to AMVP-merge. The IBC BVP-merge obtains a motion vector (BV) from the IBC block vector prediction (BVP) and obtains a 2nd motion vector (BV) from the IBC merge, to form bi-predictive of the IBC. Two different indexes need to be passed, which are respectively used for an IBC BVP candidate and an IBC merge candidate.

In the bi-predictive IBC merge, two motion vectors (MVs) are obtained from the existing IBC merge list, to use two different indices that are passed.

The IBC tool list may include one or more of the foregoing tool methods. In one example, the IBC tool list is shown in Table 1 below:

TABLE 1

| Name | Introduction |
|---|---|
| ABVR | Adaptive block vector precision |
| FIBC | Predictive value filtering method for IBC |
| SIBC and RRIBC | A predicted value/reconstructed value of |
| | IBC is flipped |
| IBC-LIC | The predicted value of the IBC is corrected |
| | by using a linear model |
| IBC-TM, IBC-TM-AMVP, | IBC template matching related tool |
| and IBC-TM-MRG | |
| IBC Bi-Pred | Weighted prediction is performed based on |
| | two IBC predicted values |
| IBC-CHIP | Combination of an IBC predicted value, an |
| | intra-frame predicted value, and an inter- |
| | frame predicted value |
| IBC-GPM | IBC predicted values are combined |
| | according to a weighted template |
| IBC-MBVD | An IBC block vector prediction method |

In some embodiments, the IBC parameter may include a plurality of tool method set parameters. The tool method set parameters are parameters corresponding to a tool method set formed by one or more tool methods in the IBC tool list. The tool method set parameters may represent a tool method set used when the current video bitstream is encoded.

The various IBC sub-modes are configured for indicating a tool method used when the video bitstream is encoded. A tool method corresponding to each IBC sub-mode forms a tool method set parameter, and each sub-mode has a corresponding tool method set parameter.

Refer to Table 2 below. Table 2 shows differences in an encoding effect between a camera photographing sequence formed in a camera photographing manner and a screen content sequence formed in a computer generation manner when various tool methods are applied.

TABLE 2

| IBC tool | Camera photographing sequence | Screen content sequence |
|---|---|---|
| ABVR | Motion vector precision loss easily | The precision loss has a relatively |
| | leads to a decrease in prediction | small impact on prediction |
| | precision, precision performance is | precision, and a larger resolution |
| | relatively poor for motion vector | can save a bit rate and improve |
| | precision loss that is greater than 1 | performance |
| | pixel (pel) and additional | |
| | complexity is introduced, and the | |
| | IBC tool can be turned off | |
| IBC filtering related | The sequence has a lot of noise, and | There are many edges, and filtering |
| tool (such as FIBC) | filtering helps improve performance | easily leads to a decrease in quality |
| Tools such as SIBC | There are lighting changes and | There is a large amount of content |
| and RRIBC for | noise, and therefore, there is hardly | that is similar after flipping |
| flipping a predicted | any matching content after flipping | |
| value/reconstructed | | |
| value | | |
| IBC-LIC | A linear model is exported to | A linear model is exported to |
| | correct the predicted value, so that | correct the predicted value, so that |
| | coding performance can be | coding performance can be |
| | improved | improved |
| Tools such as IBC- | Content is complex, template | Content is simple, template |
| TM, IBC-TM- | matching precision is relatively low, | matching precision is relatively |
| AMVP, and IBC- | and relatively high complexity is | high, and relatively high |
| TM-MRG that use a | introduced | complexity is introduced |
| template matching | | |
| technology | | |
| IBC-BI-PRED | Content relevance is relatively low, | Content relevance is relatively |
| | and only a reference block is | high, and a reference block is |
| | exported from the merge list, | directly selected from the merge |
| | resulting in relatively low | list, resulting in high prediction |
| | prediction precision | precision |
| IBC-CIIP | Content relevance is relatively low, | Content relevance is relatively |
| | and only a reference block is | high, and a reference block is |
| | exported from the merge list, | directly selected from the merge |
| | resulting in relatively low | list, resulting in high prediction |
| | prediction precision | precision |
| IBC-GPM | Content relevance is relatively low, | Content relevance is relatively |
| | and only a reference block is | high, and a reference block is |
| | exported from the merge list, | directly selected from the merge |
| | resulting in relatively low | list, resulting in high prediction |
| | prediction precision | precision |
| IBC-MBVD | Content relevance is relatively low, | Content relevance is relatively |
| | and only a reference block is | high, and a reference block is |
| | exported from the merge list, | directly selected from the merge |
| | resulting in relatively low | list, resulting in high prediction |
| | prediction precision | precision |
| CBVP | A predicted block vector is exported | A predicted block vector is |
| | based on classes, so that encoding | exported based on classes, so that |
| | performance can be improved | encoding performance can be |
| | | improved |

In some embodiments, the tool method set parameter includes a plurality of tool method parameters (such as ABVR and FIBC in Table 1). A value of the tool method parameter is a first preset parameter (such as 0) or a second preset parameter (such as 1). When the value of the tool method parameter is set to the first preset parameter, it indicates that the tool method is not used in the tool method set parameter. When the value of the tool method parameter is set to the second preset parameter, it indicates that the tool method is used in the tool method set parameter.

Based on Table 2, a corresponding tool method set parameter can be separately set for an IBC mode (such as a sub-mode 1) corresponding to a camera photographing manner and an IBC mode (such as a sub-mode 2) corresponding to a computer generation manner. For example, the sub-mode 1 corresponds to a tool method set parameter 1, and the sub-mode 2 corresponds to a tool method set parameter 2.

In an example, the tool method set parameter 1 and the tool method set parameter 2 are shown in Table 3 below:

TABLE 3

| | Tool method set | Tool method set |
|---|---|---|
| IBC tool | parameter 1 | parameter 2 |
| ABVR | 0 | 1 |
| FIBC | 1 | 0 |
| SIBC and RRIBC | 0 | 1 |
| IBC-LIC | 1 | 1 |
| IBC-TM, IBC-TM-AMVP, | 0 | 1 |
| and IBC-TM-MRG | | |
| IBC-Bi-Pred | 0 | 1 |
| IBC-CIIP | 0 | 1 |
| IBC-GPM | 0 | 1 |
| IBC-MBVD | 0 | 1 |
| CBVP | 1 | 1 |

The tool method set parameter 1 includes various tool methods used when an image generation manner is that video data obtained by photographing by a camera is encoded, and the tool method set parameter 2 includes various tool methods used when an image generation manner is that video data generated by a computer is encoded.

When IBC is performed, the image generation manner is that a video bitstream obtained by photographing by the camera is encoded by using the tool method set parameter 1, and the image generation manner is that a video bitstream generated by the computer is encoded by using the tool method set parameter 2, so that the IBC parameter matches the image generation manner of the video bitstream, to improve encoding performance of the video data of different image generation manners.

In some embodiments, the tool method set parameter 1 may include one or more of the foregoing tool method parameters, and the tool method set parameter 2 may also include one or more of the foregoing tool method parameters. The tool method set parameter 1 and the tool method set parameter 2 are different.

For example, both the tool method set parameter 1 and the tool method set parameter 2 include an ABVR parameter and a CBVP parameter. A value of the ABVR parameter in the tool method set parameter 1 and a value of the CBVP parameter in the tool method set parameter 1 are respectively 0 and 1, and a value of the ABVR parameter in the tool method set parameter 2 and a value of the CBVP parameter in the tool method set parameter 2 are respectively 1 and 1.

For example, both the tool method set parameter 1 and the tool method set parameter 2 include an ABVR parameter and an FIBC parameter. A value of the ABVR parameter in the tool method set parameter 1 and a value of the FIBC parameter in the tool method set parameter 1 are respectively 0 and 1, and a value of the ABVR parameter in the tool method set parameter 2 and a value of the FIBC parameter in the tool method set parameter 2 are respectively 1 and 0.

For another example, both the tool method set parameter 1 and the tool method set parameter 2 include an ABVR parameter, an FIBC parameter, and an SIBC parameter. A value of the ABVR parameter in the tool method set parameter 1, a value of the FIBC parameter in the tool method set parameter 1, and a value of the SIBC parameter in the tool method set parameter 1 are respectively 0, 1, and 0, and a value of the ABVR parameter in the tool method set parameter 2, a value of the FIBC parameter in the tool method set parameter 2, and a value of the SIBC parameter in the tool method set parameter 2 are respectively 1, 0, and 1.

For another example, both the tool method set parameter 1 and the tool method set parameter 2 include an ABVR parameter, an FIBC parameter, and a CBVP parameter. A value of the ABVR parameter in the tool method set parameter 1, a value of the FIBC parameter in the tool method set parameter 1, and a value of the CBVP parameter in the tool method set parameter 1 are respectively 0, 1, and 1, and a value of the ABVR parameter in the tool method set parameter 2, a value of the FIBC parameter in the tool method set parameter 2, and a value of the CBVP parameter in the tool method set parameter 2 are respectively 1, 0, and 1.

For another example, both the tool method set parameter 1 and the tool method set parameter 2 include an ABVR parameter, an FIBC parameter, an IBC-LIC parameter, and a CBVP parameter. A value of the ABVR parameter in the tool method set parameter 1, a value of the FIBC parameter in the tool method set parameter 1, a value of the IBC-LIC parameter in the tool method set parameter 1, and a value of the CBVP parameter in the tool method set parameter 1 are respectively 0, 1, 1, and 1, and a value of the ABVR parameter in the tool method set parameter 2, a value of the FIBC parameter in the tool method set parameter 2, a value of the IBC-LIC parameter in the tool method set parameter 2, and a value of the CBVP parameter in the tool method set parameter 2 are respectively 1, 0, 1, and 1.

In some embodiments, there are a plurality of IBC modes, and each mode has a corresponding tool method set. For example, each mode corresponds to one or more tool method sets. In addition, the IBC modes are in one-to-one correspondence with the image generation manner of the video data. In other words, a corresponding IBC mode needs to be set for each image generation manner. Once the image generation manner of the video data is determined, the IBC mode corresponding to the image generation manner may be determined, so that one of the one or more tool method sets corresponding to the IBC mode is used for encoding.

If the IBC mode includes a sub-mode 1 and a sub-mode 2, when the image generation manner is camera photographing, the IBC mode is the sub-mode 1, and when the image generation manner is computer generation, the IBC mode is the sub-mode 2. The sub-mode 1 can correspond to the tool method set parameter 1 in Table 3, and the sub-mode 2 can correspond to the tool method set parameter 2 in Table 3, to quickly determine a tool method set for performing IBC during encoding.

In this way, the encoding performance of the video data of different image generation manners can be improved by encoding the video data of different image generation manners by using a matching IBC tool method set.

A tool method set parameter corresponding to video data of each image generation manner can be obtained by conducting encoding experiments on a large amount of video data and verifying experiment data, to obtain a tool method set parameter that can meet a user requirement for the encoding performance of the video data of each image generation manner.

In some implementations, a configuration parameter of each tool method in each tool method set parameter can be determined according to a corresponding IBC mode.

Specifically, when applying each tool method in an encoding process, a configuration parameter of each tool method needs to be set first. When the configuration parameters of the tool methods are different, performance of performing encoding in the tool method varies. Therefore, for each IBC mode, the configuration parameter of each tool method corresponding to the IBC mode needs to be set, so that the configuration parameter of each tool method matches the corresponding IBC mode, which is beneficial to improving an encoding effect when the tool method set corresponding to the IBC mode is used for encoding.

For example, in the ABVR tool method, different vector precision can be selected according to different IBC modes. For another example, in the IBC-PF tool method, filtering modes of different types or different quantities can be selected according to different IBC modes; for another example, in the IBC-TM tool method, different search ranges can be selected according to different IBC modes; and for another example, in the CBVP tool method, different classification methods and sorting orders can be selected according to different IBC modes.

In some embodiments, the configuration parameters of the tool methods in the tool method set parameter can be determined according to the corresponding mode and corresponding encoding information.

Specifically, in addition to determining the configuration parameters of the tool methods in the corresponding tool method set parameter according to the IBC mode, the configuration parameters of the tool methods can be further adjusted according to the encoding information. The encoding information is information required during encoding, such as a predictive encoding mode, a block size during block partitioning, and a quantizer parameter. The encoding information may further include the configuration parameters of the tool methods.

For example, an ABVR configuration parameter includes vector precision. When the block size is greater than a preset threshold, a larger vector precision configuration is used, and when the block size is less than the preset threshold, a smaller vector precision configuration is used, to adjust ABVR vector precision in the current IBC mode according to the block size during current encoding. For another example, an IBC-TM configuration parameter includes a search range, and the search range is positively correlated with the ABVR vector precision. That is, the greater the ABVR vector precision, the larger the search range.

In some implementations, to determine the tool method set used for encoding during decoding, the tool method set parameter corresponding to each IBC mode needs to be defined in the decoding indication information. To be applicable to all encoded images, the tool method set parameter may be set in the sequence-level parameter information (such as in a sequence header of a video sequence).

In some embodiments, a configuration parameter that is available to each tool method and that is included in the tool method set parameter can also be defined in the sequence-level parameter information (such as the sequence header).

In some embodiments, the tool method set parameter includes a plurality of tool method parameters, and values of the tool method parameters are a plurality of preset parameter values. The configuration parameters of the tool methods correspond to the preset parameter values. For example, the preset parameter values are in one-to-one correspondence with the configuration parameters, or one preset parameter value corresponds to a plurality of configuration parameters.

In this way, the values of the tool method parameters are set, so that the configuration parameters of the tool methods are determined when encoding is performed by using a tool method set corresponding to the tool method set parameter, to implement precise configuration of the tool method set parameters, which is beneficial to improving encoding performance.

In some embodiments, a mapping relationship table of configuration parameters and corresponding preset parameter values of various tool methods can be defined in the sequence header or directly set at the encoder side and the decoder side. After determining the values of the tool method parameters in the tool set method parameters, the mapping table can be queried, to obtain the configuration parameters of the tool methods when IBC is performed.

For example, values of an ABVR tool method parameter include {0, 1}, and ABVR configuration parameters (such as vector precision) include {1 pixel, 4 pixels}. When preset parameter values are in one-to-one correspondence with the configuration parameters, a mapping relationship between preset parameter values of the ABVR tool method parameter and the ABVR configuration parameters is shown in Table 4 below:

TABLE 4

| ABVR preset | ABVR configuration |
|---|---|
| parameter value | parameter |
| 0 | 1 pixel |
| 1 | 4 pixels |

With reference to Table 3 and Table 4, in other words, when the IBC mode is the sub-mode 1, a value of the ABVR tool method parameter is 0, that is, an ABVR configuration parameter corresponding to the sub-mode 1 is 1 pixel; and when the IBC mode is a sub-mode 2, a value of the ABVR tool method parameter is 1, that is, an ABVR configuration parameter corresponding to the sub-mode 2 is 4 pixels.

When one preset parameter value corresponds to one or more configuration parameters, a mapping relationship between preset parameter values of the ABVR tool method parameter and the ABVR configuration parameters is shown in Table 5 below:

TABLE 5

| ABVR preset | ABVR configuration |
|---|---|
| parameter value | parameter |
| 0 | 1 pixel |
| 1 | 1 pixel and 4 pixels |

With reference to Table 3 and Table 5, in other words, when the IBC mode is the sub-mode 1, a value of the ABVR tool method parameter is 0, that is, an ABVR configuration parameter corresponding to the sub-mode 1 is 1 pixel; and when the IBC mode is a sub-mode 2, a value of the ABVR tool method parameter is 1, that is, an ABVR configuration parameter corresponding to the sub-mode 2 includes 1 pixel and 4 pixels.

In some implementations, the intra block copy parameter includes at least one of a flag parameter and a mode parameter. The flag parameter is configured for representing whether intra block copy is allowed, and the mode parameter is configured for representing an intra block copy mode. The mode parameter matches the image generation manner of the video data.

Specifically, as described above, the tool method set parameters corresponding to the IBC modes have been defined in the sequence header. A specific IBC mode that is used during video sequence encoding has not been defined. Therefore, the IBC parameter may further include at least one of the flag parameter and the mode parameter. Whether the video sequence allows the IBC is determined through the flag parameter, and a specific IBC mode is determined through the mode parameter when the video sequence is encoded. In other words, the mode parameter matches the image generation manner of the video data. Performing, by using tool method sets corresponding to different IBC modes, encoding based on the video data of different image generation manners can improve encoding performance.

During decoding, after determining that the IBC is performed on the video sequence by parsing the flag parameter, the IBC mode can be determined during video sequence encoding by parsing the mode parameter. The tool method set parameter corresponding to the IBC mode is queried in the sequence header, to implement decoding indication for the IBC, so that the decoder side correctly performs decoding, to improve encoding and decoding performance.

In some implementations, a value of the flag parameter may be a first preset value (for example, 0) or a second preset value (for example, 1). The first preset value and the second preset value are different. When the value of the flag parameter is the first preset value, intra block copy is not performed (that is, use of the IBC mode is not allowed). When the value of the flag parameter is the second preset value, intra block copy is performed (that is, use of the IBC mode is not allowed).

In some embodiments, the IBC mode is not allowed for an image P and an image B, that is, a value of the flag parameter of the IBC parameter in the image header and/or the sequence header that correspond/corresponds to the image P and the image B is set to the first preset value. Because an effect of performing IBC on the image P and the image B has a relatively poor result, the image P and the image B are not allowed to use the IBC mode.

In some embodiments, when the value of the flag parameter is the first preset value, the mode parameter is not configured for encoding (for example, the mode parameter is not set) and decoding, to reduce a calculation amount of encoding and decoding. As shown in Table 6 below, when the flag parameter in the sequence header is the first preset value, the mode parameter in the sequence header is not encoded or decoded.

In some implementations, values of the mode parameter include a plurality of preset values, and the plurality of preset values are different from each other. When the values of the mode parameter are different preset values, intra block copy modes are different, and the intra block copy modes are in one-to-one correspondence with the preset values.

Specifically, a quantity of preset values is the same as a quantity of preset IBC modes, that is, the IBC modes are in one-to-one correspondence with the preset values. If the plurality of preset values include 0 and 1, the IBC modes include the sub-mode 1 and the sub-mode 2. The preset value 0 corresponds to the IBC sub-mode 1, and the preset value 1 corresponds to the IBC sub-mode 2.

In this way, encoding is performed on the mode parameter, to perform decoding indication on a target IBC mode (such as the sub-mode 1 or the sub-mode 2) used during encoding.

In some embodiments, the image generation manner corresponding to the video bitstream includes a first generation manner and a second generation manner, the first generation manner and the second generation manner are different, a value of the mode parameter matches the image generation manner, a value of the mode parameter includes a first preset value (for example, 0) or a second preset value (for example, 1), the first preset value matches the first generation manner, and the second preset value matches the second generation manner.

In this way, the image generation manner, the value of the mode parameter, and the IBC mode can be in one-to-one correspondence with each other. Video data of different image generation manners is encoded through the corresponding IBC mode, and a decoding indication is provided through the value of the corresponding mode parameter.

In some embodiments, the first generation manner is one of generation by capturing with a camera and generation by a computer, and the second generation manner is the other of generation by capturing with the generation by a computer.

For example, the flag parameter seq_ibc_flag and the mode parameter seq_ibc_mode are defined in the sequence header, as shown in Table 6 below:

TABLE 6

| seq_ibc_flag | seq_ibc_mode | Semantics |
|---|---|---|
| 0 | x | An IBC mode is not allowed to be used, and seq_ibc_mode does not |
| | | need to be decoded |
| 1 | 0 | An IBC mode is allowed to be used, and an IBC sub-mode 1 is used |
| 1 | 1 | An IBC mode is allowed to be used, and an IBC sub-mode 2 is used |

A bitstream corresponding to Table 6 is described as follows:

seq_ibc_flag
if(SeqIbcFlag) {
seq_ibc_mode
}

A sequence header intra block copy prediction flag seq_ibc_flag is a binary variable. A value of ‘1’ indicates that intra block copy prediction (namely, IBC) can be used; and a value of ‘0’ indicates that intra block copy prediction is not used. A value of SeqIbcFlag is equal to a value of seq_ibc_flag. If seq_ibc_flag does not exist in the bitstream, the value of SeqIbcFlag is 0.

A sequence header intra block copy prediction mode flag is seq_ibc_mode. An N-bit unsigned integer (N is determined by a total quantity of modes. For example, only two sub-modes are allowed, and N=log 2 (2)=1) indicates use of intra block copy prediction. The value of SeqIbcMode is equal to the value of seq_ibc_mode. If seq_ibc_mode does not exist in the bitstream, the value of SeqIbcMode is 0.

For another example, in the image header, the flag parameter pic_ibc_flag and the mode parameter pic_ibc_mode are defined, as shown in Table 7 below:

TABLE 7

| pic_ibc_flag | pic_ibc_mode | Semantics |
|---|---|---|
| 0 | x | An IBC mode is not allowed to be used, and pic_ibc_mode does not |
| | | need to be decoded |
| 1 | 0 | An IBC mode is allowed to be used, and an IBC sub-mode 1 is used |
| 1 | 1 | An IBC mode is allowed to be used, and an IBC sub-mode 2 is used |

A bitstream corresponding to Table 7 is described as follows:

| | |
|---|---|
| pic_ibc_flag | u(1) |
| if(PicIbcFlag) { | |
| pic_ibc_mode | u(n) |
| } | |

Below, n-ceil (log 2(total_mode_num)), where total_mode_num is a total quantity of allowed modes, and the value may be preset.

An image header intra block copy prediction flag pic_ibc_flag is a binary variable. A value of ‘l’ indicates that intra block copy prediction can be used; and a value of ‘O’ indicates that intra block copy prediction is not used. A value of PicIbcFlag is equal to a value of pic_ibc_flag. If pic_ibc_flag does not exist in the bitstream, the value of PicIbcFlag is 0.

An image header intra block copy prediction mode flag is pic_ibc_mode. An N-bit unsigned integer (N is determined by a total quantity of modes. For example, only two sub-modes are allowed, and N=log 2(2)=1) indicates use of a sub-mode type. The value of PicIbcMode is equal to the value of pic_ibc_mode. If pic_ibc_mode does not exist in the bitstream, the value of PicIbcMode is 0.

For another example, in the slice header, the flag parameter slice_ibc_flag and the mode parameter slice_ibc_mode are defined, as shown in Table 8 below:

TABLE 8

| slice_ibc_flag | slice_ibc_mode | Semantics |
|---|---|---|
| 0 | X | An IBC mode is not allowed to be used, and pic_ibc_mode does not |
| | | need to be decoded |
| 1 | 0 | An IBC mode is allowed to be used, and an IBC sub-mode 1 is used |
| 1 | 1 | An IBC mode is allowed to be used, and an IBC sub-mode 2 is used |

A bitstream corresponding to Table 8 is described as follows:

| | |
|---|---|
| slice_ibc_flag | u(1) |
| if(SliceIbcFlag) { | |
| slice_ibc_mode | u(n) |
| } | |

A slice header intra block copy prediction flag slice_ibc_flag is a binary variable. A value of ‘l’ indicates that intra block copy prediction can be used; and a value of ‘O’ indicates that intra block copy prediction is not used. A value of SliceIbcFlag is equal to a value of slice_ibc_flag. If slice_ibc_flag does not exist in the bitstream, the value of SliceIbcFlag is 0.

A slice header intra block copy prediction mode flag is slice_ibc_mode. An N-bit unsigned integer (N is determined by a total quantity of modes. For example, only two sub-modes are allowed, and N=log 2 (2)=1) indicates use of a sub-mode type. The value of SliceIbcMode is equal to the value of slice_ibc_mode. If slice_ibc_mode does not exist in the bitstream, the value of SliceIbcMode is 0.

In some embodiments, one preset value may correspond to a plurality of IBC modes, so that one or more of the available IBC modes are used for encoding according to an actual requirement.

For example, the IBC modes include a sub-mode 1, a sub-mode 2, and a sub-mode 3, and the flag parameter seq_ibc_flag and the mode parameter seq_ibc_mode are defined in the sequence header, as shown in Table 9 below:

TABLE 9

| seq_ibc_flag | seq_ibc_mode | Semantics |
|---|---|---|
| 0 | X | An IBC mode is not allowed to be used, and |
| | | seq_ibc_mode does not need to be decoded |
| 1 | 0 | An IBC mode is allowed to be used, and an IBC sub- |
| | | mode 1 and an IBC sub-mode 2 are used |
| 1 | 1 | An IBC mode is allowed to be used, and an IBC sub- |
| | | mode 2 and an IBC sub-mode 3 are used |

In some implementations, priorities of the sequence-level parameter information, the image-level parameter information, the slice-level parameter information, and the block-level parameter information are in descending order, and when the flag parameter in the parameter information of a first priority is the first preset value, at least one of the mode parameter in the parameter information of the first priority and the intra block copy parameter in the parameter information of a second priority is not encoded or decoded, and the second priority is lower than the first priority.

Specifically, after determining that intra block copy is not allowed based on a high-priority (namely, the first priority) flag parameter, encoding or decoding (that is, at least one of encoding and decoding is not performed) may be selectively not performed on at least one of a high-priority mode parameter, a low-priority (namely, the second priority) flag parameter, or a low-priority mode parameter, to avoid redundant encoding and reduce a calculation amount of encoding and decoding.

For example, after it is determined, based on the high-priority flag parameter, that intra block copy is not allowed, the high-priority mode parameter is not encoded or decoded; or after it is determined, based on the high-priority flag parameter, that intra block copy is not allowed, the low-priority mode parameter is not encoded or decoded; or after it is determined, based on the high-priority flag parameter, that intra block copy is not allowed, the low-priority flag parameter is not encoded or decoded.

For another example, after it is determined, based on the high-priority flag parameter, that intra block copy is not allowed, encoding or decoding is not performed on the high-priority mode parameter; or after it is determined, based on the high-priority flag parameter, that intra block copy is not allowed, encoding or decoding is not performed on the low-priority mode parameter; or after it is determined, based on the high-priority flag parameter, that intra block copy is not allowed, encoding or decoding is not performed on the low-priority flag parameter; or after it is determined, based on the high-priority flag parameter, that intra block copy is not allowed, encoding or decoding is not performed on the high-priority mode parameter and the low-priority mode parameter; or after it is determined, based on the high-priority flag parameter, that intra block copy is not allowed, encoding or decoding is not performed on the low-priority mode parameter and the low-priority flag parameter; or after it is determined, based on the high-priority flag parameter, that intra block copy is not allowed, encoding or decoding is not performed on the high-priority mode parameter and the low-priority flag parameter.

For another example, after it is determined, based on the high-priority flag parameter, that intra block copy is not allowed, encoding or decoding is not performed on the high-priority mode parameter, the low-priority mode parameter, and the low-priority flag parameter.

the parameter information of the first priority may be any one of the sequence-level parameter information, the image-level parameter information, or the slice-level parameter information. The parameter information of the second priority may be any one of the image-level parameter information, the slice-level parameter information, or the block-level parameter information.

In other words, when the flag parameter in the sequence-level parameter information is set to the first preset value, the sequence-level mode parameter, the image-level IBC parameter, the slice-level IBC parameter, and the block-level IBC parameter are not decoded; when the flag parameter in the image-level parameter information is set to the first preset value, the image-level mode parameter, the slice-level IBC parameter, and the block-level IBC parameter are not decoded; and when the flag parameter in the slice-level parameter information is set to the first preset value, the slice-level mode parameter and the block-level IBC parameter are not decoded.

In an example, refer to Table 10 below. When the flag parameter in the image header is set to the first preset value, the mode parameter in the image header and the IBC parameter in the slice header are not decoded.

TABLE 10

| pic_ibc_flag | pic_ibc_mode | slice_ibc_flag | slice_ibc_mode | Semantics |
|---|---|---|---|---|
| 0 | X | X | X | An IBC mode is not allowed to |
| | | | | be used, and pic_ibc_mode, |
| | | | | slice_ibc_flag, and |
| | | | | slice_ibc_mode are not decoded |

In some embodiments, when the flag parameter in the parameter information of the first priority is set to the second preset value, it indicates that the IBC is allowed. If no mode parameter exists in the parameter information of the first priority, the mode parameter for the IBC needs to be determined in parameter information of a next priority, to determine an IBC mode of at least one of an encoding image, a slice, and a block following a next priority.

In some embodiments, when both the flag parameter of the first priority and the flag parameter of the second priority are the second preset value, if the mode parameter in the parameter information of the first priority and the mode parameter of the second priority are inconsistent, encoding is performed in the IBC mode corresponding to the mode parameter of the second priority.

Specifically, refer to Table 11 below. The IBC is allowed to be performed on both the sequence header and the image header (that is, both the flag parameter of the sequence header and the flag parameter of the image header are set to 1). If the mode parameter of the sequence header and the mode parameter of the image header are inconsistent, for example, the mode parameter of the sequence header is 0 and the mode parameter of the image header is 1, an encoded image following the image header is encoded according to an IBC mode (for example, the sub-mode 2) corresponding to the mode parameter of 1, to implement image-level IBC mode setting.

TABLE 11

| seq_ibc_flag | seq_ibc_mode | pic_ibc_flag | pic_ibc_mode | Semantics |
|---|---|---|---|---|
| 1 | 0 | 1 | 1 | An IBC mode is allowed to be |
| | | | | used, and an IBC sub-mode 2 |
| | | | | is used |

Refer to Table 12 below. The IBC is allowed to be performed on both the image header and the slice header (that is, both the flag parameter of the image header and the flag parameter of the slice header are set to 1). If the mode parameter of the image header and the mode parameter of the slice header are inconsistent, for example, the mode parameter of the image header is 1 and the mode parameter of the slice header is 0, an image slice following the slice header is encoded according to an IBC mode (for example, the sub-mode 1) corresponding to the mode parameter of 0, to implement slice-level IBC mode setting.

TABLE 12

| pic_ibc_flag | pic_ibc_mode | slice_ibc_flag | slice_ibc_mode | Semantics |
|---|---|---|---|---|
| 1 | 1 | 1 | 0 | An IBC mode is allowed to be |
| | | | | used, and an IBC sub-mode 1 is |
| | | | | used |

In some implementations, the intra block copy parameter includes a flag parameter. The flag parameter is configured for representing whether intra block copy and an intra block copy mode are allowed. The flag parameter matches the image generation manner of the video data.

Specifically, to reduce a calculation amount of encoding and decoding, there is no need to separately set the mode parameter; and instead, only the flag parameter is set. The flag parameter represents whether the intra block copy and the intra block copy mode are allowed.

In some embodiments, whether the IBC is allowed is determined through different values of the flag parameter. For example, when a value of the flag parameter is the first preset value (such as 0), it is determined that the IBC is not allowed, and when a value of the flag parameter is a value other than the first preset value, it is determined that the IBC is allowed.

In some embodiments, the IBC mode is not allowed for an image P and an image B, that is, a value of the flag parameter of the IBC parameter in the image header and/or the sequence header that correspond/corresponds to the image P and the image B is set to the first preset value. Because an effect of performing IBC on the image P and the image B has a relatively poor result, the image P and the image B are not allowed to use the IBC mode.

In some embodiments, a specific IBC mode is determined by taking a different value of the flag parameter other than the first preset value. For example, a plurality of second preset values respectively correspond to the IBC modes. For example, the IBC modes are in one-to-one correspondence with the second preset values.

In other words, when the flag parameter includes different second preset values, it is determined that the IBC is allowed, and the IBC modes are different.

In some embodiments, the image generation manner corresponding to the video bitstream includes a first generation manner and a second generation manner, the first generation manner and the second generation manner are different, the value of the flag parameter matches the image generation manner corresponding to the video bitstream, a value of a mode parameter includes two second preset values, and the two second preset values respectively match the first generation manner and the second generation manner. For example, the two second preset values are respectively 1 and 2, 1 corresponds to the first generation manner, and 2 corresponds to the second generation manner.

In this way, the image generation manner, the value of the flag parameter (specifically, the second preset value), and the IBC mode can be in one-to-one correspondence with each other. Video data of different image generation manners are encoded through the corresponding IBC mode, and a decoding indication is provided through the corresponding second preset value.

Refer to Table 13 below. An example in which the IBC modes include a sub-mode 1 and a sub-mode 2 is used, and the flag parameter seq_ibc_flag in the IBC parameter is defined in the sequence header.

TABLE 13

| seq_ibc_flag | Semantics |
|---|---|
| 0 | An IBC mode is not allowed to be used, and seq_ibc_mode does not |
| | need to be decoded |
| 1 | An IBC mode is allowed to be used, and an IBC sub-mode 1 is used |
| 2 | An IBC mode is allowed to be used, and an IBC sub-mode 2 is used |

A bitstream of Table 13 is described as follows:

| | |
|---|---|
| seq_ibc_flag | u(n) |

A sequence header block copy mode flag is seq_ibc_flag. An N-bit unsigned integer (N is determined by a total quantity of modes. For example, only two sub-modes are allowed, and N=log 2 (2)=1). A value of ‘0’ indicates that block copy intra prediction is not used, and a value greater than ‘0’ indicates that the intra block copy prediction mode can be used and indicates a sub-mode type of the block copy intra prediction mode. A value of SeqIbcFlag is equal to a value of seq_ibc_flag. If seq_ibc_flag does not exist in the bitstream, the value of SeqIbcFlag is 0.

Table 14 shows the flag parameter pic_ibc_flag in the IBC parameters defined in the image header.

TABLE 14

| pic_ibc_flag | Semantics |
|---|---|
| 0 | An IBC mode is not allowed to be used, and decoding is not needed |
| 1 | An IBC mode is allowed to be used, and an IBC sub-mode 1 is used |
| 2 | An IBC mode is allowed to be used, and an IBC sub-mode 2 is used |

A bitstream of Table 14 is described as follows:

| | |
|---|---|
| pic_ibc_flag | u(n) |

An image header block copy mode flag is pic_ibc_flag. An N-bit unsigned integer (N is determined by a total quantity of modes. For example, only two sub-modes are allowed, and N=log 2 (2)=1). A value of ‘0’ indicates that intra block copy prediction is not used, and a value greater than ‘0’ indicates that the intra block copy prediction mode can be used and indicates a sub-mode type of the intra block copy prediction mode. A value of PicIbcFlag is equal to a value of pic_ibc_flag. If pic_ibc_flag does not exist in the bitstream, the value of PicIbcFlag is 0.

Table 15 shows the flag parameter slice_ibc_flag in the IBC parameter defined in the slice header.

TABLE 15

| slice_ibc_flag | Semantics |
|---|---|
| 0 | An IBC mode is not allowed to be used, and decoding is not needed |
| 1 | An IBC mode is allowed to be used, and an IBC sub-mode 1 is used |
| 2 | An IBC mode is allowed to be used, and an IBC sub-mode 2 is used |

A bitstream of Table 15 is described as follows:

| | |
|---|---|
| slice_ibc_flag | u(n) |

A slice header block copy mode flag is slice_ibc_flag. An N-bit unsigned integer (N is determined by a total quantity of modes. For example, only two sub-modes are allowed, and N=log 2 (2)=1). A value of ‘0’ indicates that intra block copy prediction is not used, and a value greater than ‘0’ indicates that the intra block copy prediction mode can be used and indicates a sub-mode type of the intra block copy prediction mode. A value of SliceIbcFlag is equal to a value of slice_ibc_flag. If slice_ibc_flag does not exist in the bitstream, the value of SliceIbcFlag is 0.

In some embodiments, one second preset value may further correspond to a plurality of IBC modes, so that one or more of the available IBC modes are used for encoding according to an actual requirement.

Refer to Table 16 below. An example in which the IBC modes include a sub-mode 1, a sub-mode 2, and a sub-mode 3 is used, and the flag parameter seq_ibc_flag in the IBC parameter is defined in the sequence header.

TABLE 16

| seq_ibc_flag | Semantics |
|---|---|
| 0 | An IBC mode is not allowed to be used, and seq_ibc_mode does not |
| | need to be decoded |
| 1 | An IBC mode is allowed to be used, and an IBC sub-mode 1 and an |
| | IBC sub-mode 2 are used |
| 2 | An IBC mode is allowed to be used, and an IBC sub-mode 2 and an |
| | IBC sub-mode 3 are used |

Table 17 is a specific embodiment of a high-level syntax. In this embodiment, two IBC sub-modes (the sub-mode 1 and the sub-mode 2) are allowed

TABLE 17

| seq_ibc_flag | pic_ibc_flag | pic_ibc_mode | Semantics |
|---|---|---|---|
| 0 | x | x | An IBC mode is not allowed to be used, and |
| | | | pic_ibc_flag and pic_ibc_mode do not need to be |
| | | | decoded |
| 1 | 0 | x | An IBC mode is not allowed to be used, |
| | | | pic_ibc_flag needs to be decoded, and |
| | | | pic_ibc_mode does not need to be decoded |
| 1 | 1 | 0 | An IBC mode is allowed to be used, and an IBC |
| | | | sub-mode 1 is used |
| 1 | 1 | 1 | An IBC mode is allowed to be used, and an IBC |
| | | | sub-mode 2 is used |

A bitstream of a sequence header is described as follows:

| | |
|---|---|
| seq_ibc_flag | u(1) |

A sequence header intra block copy prediction flag seq_ibc_flag is a binary variable.

A value of ‘1’ indicates that intra block copy prediction can be used; and a value of ‘0’ indicates that intra block copy prediction is not used. A value of SeqIbcFlag is equal to a value of seq_ibc_flag. If seq_ibc_flag does not exist in the bitstream, the value of SeqIbcFlag is 0.

A bitstream of an image header is described as follows:

| | |
|---|---|
| if(SeqIbcFlag) { | |
| pic_ibc_flag | u(1) |
| if(SeqIbcFlag && PicIbcFlag) { | |
| pic_ibc_mode | u(1) |
| } | |
| } | |

An image header intra block copy prediction flag pic_ibc_flag is a binary variable. A value of ‘l’ indicates that intra block copy prediction can be used; and a value of ‘0’ indicates that intra block copy prediction is not used. A value of PicIbcFlag is equal to a value of pic_ibc_flag. If pic_ibc_flag does not exist in the bitstream, the value of PicIbcFlag is 0.

An image header intra block copy prediction mode flag is pic_ibc_mode. An N-bit unsigned integer (N is determined by a total quantity of modes. For example, only two sub-modes are allowed, and N=log 2(2)=1) indicates use of a sub-mode type. The value of PicIbcMode is equal to the value of pic_ibc_mode. If pic_ibc_mode does not exist in the bitstream, the value of PicIbcMode is 0.

In addition, if the ABVR tool is controlled in this instance, there are the following bitstream descriptions at an encoding unit level:

| | |
|---|---|
| if (PicIbcFlag && PicIbcMode == 1) | |
| abvr_index | ae(v) |

The adaptive block vector precision index abvr_index
is configured for determining block vector precision of an encoding unit. A value of AbvrIndex is equal to abvr_index. If the value of AbvrIndex is ‘0’, it indicates that the block vector precision is 1 pel. If the value of AbvrIndex is ‘1’, it indicates that the block vector precision is 4 pel. If abvr_index does not exist in the bitstream, the value of AbvrIndex is 0.

In addition, if an IBC-related filtering tool is controlled in this instance, there are the following bitstream descriptions at an encoding unit level:

| | |
|---|---|
| if (PicIbcFlag && PicIbcMode == 0) | |
| ibc_filter_flag | ae(v) |

The intra block copy prediction filter flag ibc_filter_flag is configured for determining whether to use intra block copy prediction filtering. A value of IbcFilterFlag is equal to ibc_filter_flag. If the value of IbcFilterFlag is ‘0’, it indicates that intra block copy prediction filtering is not used. If the value of IbcFilterFlag is ‘1’, it indicates that intra block copy prediction filtering is used. If ibc_filter_flag does not exist in the bitstream, the value of IbcFilterFlag is 0.

According to the method described in the foregoing embodiments, an embodiment of this application further provides a video encoding method. FIG. 8 is a schematic flowchart of a video encode method according to an embodiment of this application. The following steps are specifically included.
Step 021: Obtain video data.
Step 022: Encode and compress the video data, to obtain a video bitstream, where decoding indication information of the video bitstream includes an intra block copy parameter, and the intra block copy parameter is configured for providing a decoding indication on an intra block copy mode.

The video encoding process and the video decoding process are reversible. Therefore, for syntax definition involved in the video encoding method provided in the embodiments of this application, refer to the foregoing video decoding method embodiments. Details are not described herein again.

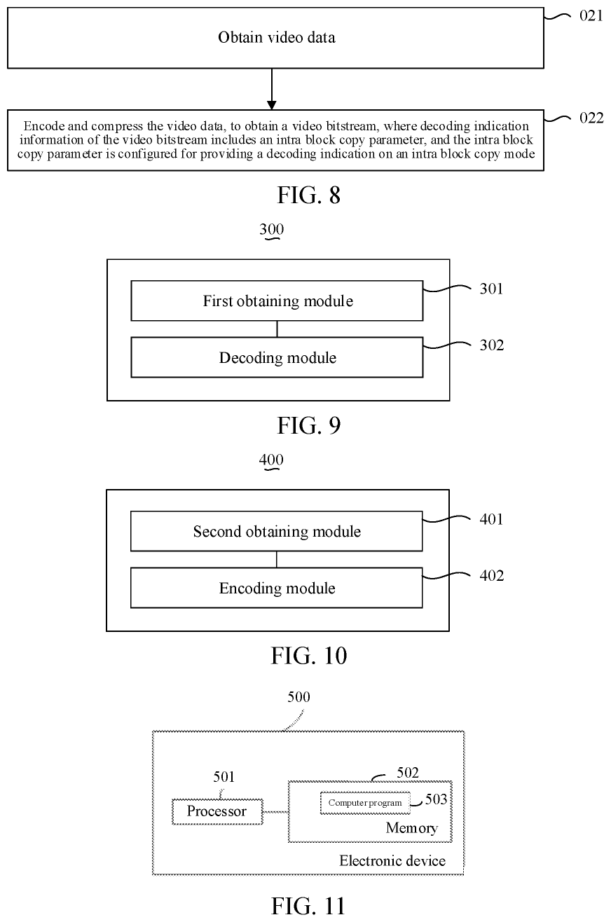

According to the method described in the foregoing embodiments, an embodiment of this application further provides a video decoding apparatus, configured to perform steps of the video decoding method. FIG. 9 is a schematic structural diagram of a video decoding apparatus 300 according to an embodiment of this application. The video decoding apparatus 300 includes a first obtaining module 301 and an encoding module 302.

The first obtaining module 301 is configured to obtain a video bitstream, the video bitstream including decoding indication information, the decoding indication information including an intra block copy parameter, and the intra block copy parameter being configured for providing a decoding indication on an intra block copy mode; and

the decoding module 302 is configured to decode the video bitstream according to the decoding indication information.

Specific details of each module unit in the video decoding apparatus 300 have been described in detail in the embodiments of the video encoding method described above. Details are not be described herein again.

According to the method described in the foregoing embodiments, an embodiment of this application further provides a video encoding apparatus, configured to perform steps of the video encoding method. FIG. 10 is a schematic structural diagram of a video encoding apparatus 400 according to an embodiment of this application. The video encoding apparatus 400 includes a second obtaining module 401 and an encoding module 402.

The second obtaining module 401 is configured to obtain video data; and

the encoding module 402 is configured to encode and compress the video data, to obtain a video bitstream, decoding indication information of the video bitstream including an intra block copy parameter, and the intra block copy parameter being configured for providing a decoding indication on an intra block copy mode.

Specific details of each module unit in the video decoding apparatus 400 have been described in detail in the embodiments of the video decoding method described above. Details are not be described herein again.

In some embodiments, the video encoding apparatus and the video decoding apparatus in the embodiments of this application may be electronic devices; or may be components in an electronic device, such as integrated circuits or chips. The electronic device may be a terminal, or may be a device other than the terminal. For example, the electronic device may be a mobile phone, a tablet computer, a notebook computer, a handheld computer, a vehicle-mounted electronic device, a mobile internet device (Mobile Internet Device, MID), an augmented reality (augmented reality, AR)/virtual reality (virtual reality, VR) device, a robot, a wearable device, an ultra-mobile personal computer (ultra-mobile personal computer, UMPC), a netbook, a personal digital assistant (personal digital assistant, PDA), or the like, or the electronic device may be a server, a network attached storage (network attached storage, NAS), a personal computer (personal computer, PC), a television (television, TV), a cash machine, a self-service machine, or the like. This is not specifically limited in the embodiments of this application.

In some embodiments, as shown in FIG. 11, an embodiment of this application further provides an electronic device 500, including a processor 501, a memory 502, and a computer program stored in the memory 502 and executable on the processor 501, where the program, when executed by the processor 501, implements the processes of the embodiments of the foregoing video decoding method and the foregoing video encoding method, and can achieve the same technical effects. To avoid repetition, details are not described herein again.

The electronic device in the embodiments of this application includes the mobile electronic device and the non-mobile electronic device.

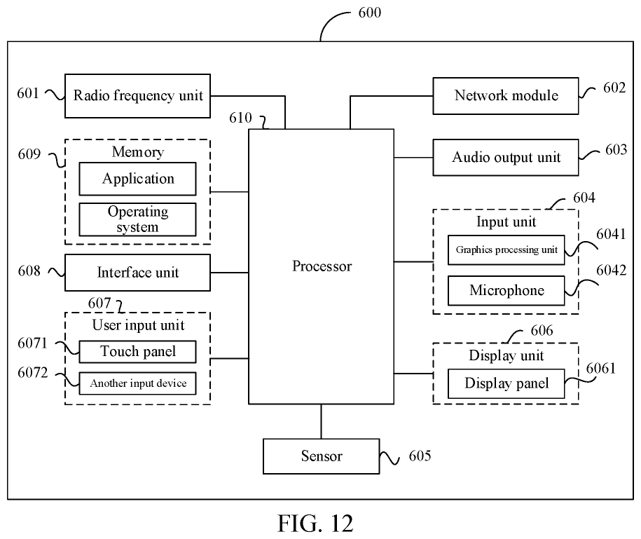

FIG. 12 is a schematic diagram of a hardware structure of an electronic device according to an embodiment of this application.

The electronic device 600 includes, but is not limited to, components such as a radio frequency unit 601, a network module 602, an audio output unit 603, an input unit 604, a sensor 605, a display unit 606, a user input unit 607, an interface unit 608, a memory 609, and a processor 610.

A person skilled in the art can understand that the electronic device 600 may further include a power supply (such as a battery) that supplies power to each component. The power supply may be logically connected to the processor 610 by using a power supply management system, to implement functions such as charging and discharging management, and power consumption management by using the power supply management system. The electronic device structure shown in FIG. 12 does not constitute a limitation on the electronic device, and the electronic device may include more or fewer components than shown, or combine some components, or have different component arrangements. This is not described herein again.

In this embodiment of this application, the input unit 604 may include a graphics processing unit (Graphics Processing Unit, GPU) 6041 and a microphone 6042. The graphics processing unit 6041 processes image data of a static picture or a video that is obtained by an image capturing apparatus (for example, a camera) in a video capturing mode or an image capturing mode. The display unit 606 may include a display panel 6061, and the display panel 6061 may be configured by using a liquid crystal display, an organic light-emitting diode, or the like. The user input unit 607 includes at least one of a touch panel 6071 and another input device 6072. The touch panel 6071 is also referred to as a touchscreen. The touch panel 6071 may include two parts, a touch detection apparatus and a touch controller. The another input device 6072 may include, but not limited to, a physical keyboard, a functional key (such as a volume control key or a switch key), a track ball, a mouse, and a joystick, which are not described herein in detail.

The memory 609 may be configured to store a software program and various data. The memory 609 may mainly include a first storage area storing a program or instructions and a second storage area storing data. The first storage area may store an operating system, an application program, or instructions required by at least one function (such as a sound playback function and an image display function), and the like. In addition, the memory 609 may include a volatile memory or a non-volatile memory, or the memory 609 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DR RAM). The memory 609 in this embodiment of this application includes but is not limited to these memories and any other suitable types of memories.

The processor 610 may include one or more processing units; and the processor 610 integrates an application processor and a modem processor. The application processor mainly processes operations relating to an operating system, a user interface, an application program, and the like. The modem processor mainly processes a wireless communication signal, such as a baseband processor. The foregoing modem processor may either not be integrated into the processor 610.

An embodiment of this application further provides a non-transitory computer-readable storage medium, storing a computer program, where when executed by a processor, the computer program implements the various processes of the embodiments of the foregoing video decoding method and the foregoing video encoding method, and can achieve the same technical effects. To avoid repetition, details are not described herein again.

The processor is a processor in the electronic device described in the foregoing embodiment. The computer-readable storage medium may be a computer read-only memory ROM, a random access memory RAM, a magnetic disk, an optical disc, or the like.

An embodiment of this application further provides a computer program product, which includes a computer program. When being executed by a processor, the computer program implements the foregoing video decoding method and the foregoing video encoding method. The processor may be a processor in the electronic device described in the foregoing embodiment. When being executed by the processor, the computer program implements the various processes of the embodiments of the foregoing video decoding method and the foregoing video encoding method, and may achieve the same technical effects. To avoid repetition, details are not described herein again.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. Although the embodiments of this application have been shown and described, a person of ordinary skill in the art may understand that various changes, modifications, replacements and variations may be made to the embodiments without departing from the principles and spirit of this application, and the scope of this application is as defined by the appended claims and their equivalents.

What is claimed is:

1. A video decoding method, comprising:
obtaining a video bitstream, the video bitstream comprising decoding indication information, the decoding indication information comprising a first intra block copy parameter and a second intra block copy parameter, and the first and second intra block copy parameters being configured for providing a decoding indication on an intra block copy mode including a first sub-mode corresponding to the first intra block copy parameter and a second sub-mode corresponding to the second intra block copy parameter, respectively; and
decoding the video bitstream according to the first and second intra block copy parameters.

2. The method according to claim 1, wherein the first intra block copy parameter corresponding to the first sub-mode is set in at least one of sequence-level parameter information, image-level parameter information, slice-level parameter information, and block-level parameter information of a video sequence; and the second intra block copy parameter corresponding to the second sub-mode is set in at least one of the sequence-level parameter information, the image-level parameter information, the slice-level parameter information, and the block-level parameter information of the video sequence.

3. The method according to claim 2, wherein the first intra block copy parameter corresponding to the first sub-mode is set in the image-level parameter information, and the second intra block copy parameter corresponding to the second sub-mode is set in the image-level parameter information; or the first intra block copy parameter corresponding to the first sub-mode is set in the sequence-level parameter information, and the second intra block copy parameter corresponding to the second sub-mode is set in the image-level parameter information; or the first intra block copy parameter corresponding to the first sub-mode is set in the image-level parameter information, and the second intra block copy parameter corresponding to the second sub-mode is set in the sequence-level parameter information.

4. The method according to claim 1, wherein the intra block copy mode matches an image generation manner corresponding to the video bitstream.

5. The method according to claim 1, wherein the first and second intra block copy parameters each comprise at least one of a flag parameter and a mode parameter, the flag parameter is configured for representing whether intra block copy is allowed, the mode parameter is configured for representing the intra block copy mode, a value of the flag parameter comprises a first preset value or a second preset value, and the first preset value and the second preset value are different, wherein the intra block copy is not allowed when the value of the flag parameter is the first preset value, and the intra block copy is allowed when the value of the flag parameter is the second preset value.

6. The method according to claim 5, wherein values of the mode parameter comprise a plurality of distinct preset values, and each preset value corresponds to at least one intra block copy mode.

7. The method according to claim 1, wherein the first and second intra block copy parameters each comprise a flag parameter, and a value of the flag parameter comprises a first preset value and a plurality of second preset values; when the value of the flag parameter is the first preset value, intra block copy is not performed; when the value of the flag parameter is the second preset value, the intra block copy is performed; and when the value of the flag parameter comprises the different second preset values, the intra block copy mode is different, and each second preset value corresponds to at least one intra block copy mode.

8. The method according to claim 4, wherein the image generation manner corresponding to the video bitstream comprises a first generation manner and a second generation manner, the value of the flag parameter matches the image generation manner corresponding to the video bitstream, a value of a mode parameter comprises two second preset values, and the two second preset values respectively match the first generation manner and the second generation manner.

9. The method according to claim 8, wherein the first generation manner is camera photographing generation, and the second generation manner is computer generation.

10. The method according to claim 1, wherein the first and second intra block copy parameters each correspond to a plurality of preset tool methods, the intra block copy parameter further comprises a plurality of tool method set parameters, the tool method set parameters comprise at least one of the tool methods, the tool method set parameters are set in the sequence-level parameter information, each intra block copy sub-mode is configured for indicating a tool method used when the video bitstream is encoded, and each intra block copy sub-mode has a corresponding tool method set parameter.

11. An electronic device, comprising a memory, a processor, and a computer program stored in the memory and executable on the processor, the processor, when executing the program, implementing a video decoding method including:
obtaining a video bitstream, the video bitstream comprising decoding indication information, the decoding indication information comprising a first intra block copy parameter and a second intra block copy parameter, and the first and second intra block copy parameters being configured for providing a decoding indication on an intra block copy mode including a first sub-mode corresponding to the first intra block copy parameter and a second sub-mode corresponding to the second intra block copy parameter, respectively; and
decoding the video bitstream according to the first and second intra block copy parameters.

12. The electronic device according to claim 11, wherein the first intra block copy parameter corresponding to the first sub-mode is set in at least one of sequence-level parameter information, image-level parameter information, slice-level parameter information, and block-level parameter information of a video sequence; and the second intra block copy parameter corresponding to the second sub-mode is set in at least one of the sequence-level parameter information, the image-level parameter information, the slice-level parameter information, and the block-level parameter information of the video sequence.

13. The electronic device according to claim 12, wherein the first intra block copy parameter corresponding to the first sub-mode is set in the image-level parameter information, and the second intra block copy parameter corresponding to the second sub-mode is set in the image-level parameter information; or the first intra block copy parameter corresponding to the first sub-mode is set in the sequence-level parameter information, and the second intra block copy parameter corresponding to the second sub-mode is set in the image-level parameter information; or the first intra block copy parameter corresponding to the first sub-mode is set in the image-level parameter information, and the second intra block copy parameter corresponding to the second sub-mode is set in the sequence-level parameter information.

14. The electronic device according to claim 11, wherein the intra block copy mode matches an image generation manner corresponding to the video bitstream.

15. The electronic device according to claim 11, wherein the first and second intra block copy parameters each comprise at least one of a flag parameter and a mode parameter, the flag parameter is configured for representing whether intra block copy is allowed, the mode parameter is configured for representing the intra block copy mode, a value of the flag parameter comprises a first preset value or a second preset value, and the first preset value and the second preset value are different, wherein the intra block copy is not allowed when the value of the flag parameter is the first preset value, and the intra block copy is allowed when the value of the flag parameter is the second preset value.

16. The electronic device according to claim 11, wherein the first and second intra block copy parameters each comprise a flag parameter, and a value of the flag parameter comprises a first preset value and a plurality of second preset values; when the value of the flag parameter is the first preset value, intra block copy is not performed; when the value of the flag parameter is the second preset value, the intra block copy is performed; and when the value of the flag parameter comprises the different second preset values, the intra block copy mode is different, and each second preset value corresponds to at least one intra block copy mode.

17. The electronic device according to claim 11, wherein the first and second intra block copy parameters each correspond to a plurality of preset tool methods, the intra block copy parameter further comprises a plurality of tool method set parameters, the tool method set parameters comprise at least one of the tool methods, the tool method set parameters are set in the sequence-level parameter information, each intra block copy sub-mode is configured for indicating a tool method used when the video bitstream is encoded, and each intra block copy sub-mode has a corresponding tool method set parameter.

18. A non-transitory computer-readable storage medium, having a computer program stored therein, the computer program, when executed by a processor of an electronic device, causing the electronic device to implement a video decoding method including:
obtaining a video bitstream, the video bitstream comprising decoding indication information, the decoding indication information comprising a first intra block copy parameter and a second intra block copy parameter, and the first and second intra block copy parameters being configured for providing a decoding indication on an intra block copy mode including a first sub-mode corresponding to the first intra block copy parameter and a second sub-mode corresponding to the second intra block copy parameter, respectively; and
decoding the video bitstream according to the first and second intra block copy parameters.

19. The non-transitory computer-readable storage medium according to claim 18, wherein the first intra block copy parameter corresponding to the first sub-mode is set in at least one of sequence-level parameter information, image-level parameter information, slice-level parameter information, and block-level parameter information of a video sequence; and the second intra block copy parameter corresponding to the second sub-mode is set in at least one of the sequence-level parameter information, the image-level parameter information, the slice-level parameter information, and the block-level parameter information of the video sequence.

20. The non-transitory computer-readable storage medium according to claim 19, wherein the first intra block copy parameter corresponding to the first sub-mode is set in the image-level parameter information, and the second intra block copy parameter corresponding to the second sub-mode is set in the image-level parameter information; or the first intra block copy parameter corresponding to the first sub-mode is set in the sequence-level parameter information, and the second intra block copy parameter corresponding to the second sub-mode is set in the image-level parameter information; or the first intra block copy parameter corresponding to the first sub-mode is set in the image-level parameter information, and the second intra block copy parameter corresponding to the second sub-mode is set in the sequence-level parameter information.
